(19) United States
(12) Patent Application Publication
(10) Pub. No.: US 2020/0057160 A1
(43) Pub. Date: Feb. 20, 2020

(54) MULTI-OBJECT TRACKING BASED ON LIDAR POINT CLOUD

(71) Applicant: SZ DJI TECHNOLOGY CO., LTD., Shenzhen (CN)

(72) Inventors: Chen LI, Shenzhen (CN); Lu MA, Shenzhen (CN)

(21) Appl. No.: 16/664,331

(22) Filed: Oct. 25, 2019

Related U.S. Application Data
(63) Continuation of application No. PCT/CN2017/110534, filed on Nov. 10, 2017.

(30) Foreign Application Priority Data
Apr. 28, 2017 (CN) PCT/CN2017/082601

(51) Int. Cl. G01S 17/66; G01S 7/481; G01S 17/89; G01S 7/48

(52) U.S. Cl. CPC G01S 17/66; G01S 7/4815; G01S 7/4802; G01S 17/89; G01S 7/4808; G01S 7/4816

(57) ABSTRACT

A light detection and ranging (LIDAR) based object tracking system includes a plurality of light emitter and sensor pairs and an object tracker. Each pair of the plurality of light emitter and sensor pairs is operable to obtain data indicative of actual locations of surrounding objects. The data is grouped into a plurality of groups by a segmentation module. Each group corresponds to one of the surrounding objects. The object tracker is configured to (1) build a plurality of models of target objects based on the plurality of groups, (2) compute a motion estimation for each of the target objects, and (3) feed a subset of data back to the segmentation module for further grouping based on a determination by the object tracker that the subset of data fails to map to a corresponding target object in the model.

### CROSS-REFERENCE TO RELATED APPLICATION

This application is a continuation of International Application No. PCT/CN2017/110534, filed Nov. 10, 2017, which claims priority to International Application No. PCT/CN2017/082601, filed Apr. 28, 2017, the entire contents of both of which are incorporated herein by reference.

### TECHNICAL FIELD

This present disclosure is directed generally to electronic signal processing, and more specifically, to signal processing associated components, systems and techniques in light detection and ranging (LIDAR) applications.

### BACKGROUND

With their ever increasing performance and lowering cost, unmanned movable objects, such as unmanned robotics, are now extensively used in many fields. Representative missions include real estate photography, inspection of buildings and other structures, fire and safety missions, border patrols, and product delivery, among others. For obstacle detection as well as for other functionalities, it is beneficial for the unmanned vehicles to be equipped with obstacle detection and surrounding environment scanning devices. Light detection and ranging (LIDAR, also known as “light radar”) is a reliable and stable detection technology. However, traditional LIDAR devices are typically expensive because they use multi-channel, high-density, and high-speed emitters and sensors, making most traditional LIDAR devices unfit for low cost unmanned vehicle applications.

Accordingly, there remains a need for improved techniques and systems for implementing LIDAR scanning modules, for example, such as those carried by unmanned vehicles and other objects.

### SUMMARY OF PARTICULAR EMBODIMENTS

This patent document relates to techniques, systems, and devices for conducting object tracking by an unmanned vehicle using multiple low-cost LIDAR emitter and sensor pairs.

In one exemplary aspect, a light detection and ranging (LIDAR) based object tracking system is disclosed. The system includes a plurality of light emitter and sensor pairs. Each pair of the plurality of light emitter and sensor pairs is operable to obtain data indicative of actual locations of surrounding objects. The data is grouped into a plurality of groups by a segmentation module, each group corresponding to one of the surrounding objects. The system also includes an object tracker configured to (1) build a plurality of models of target objects based on the plurality of groups, (2) compute a motion estimation for each of the target objects, and (3) feed a subset of data back to the segmentation module for further grouping based on a determination by the object tracker that the subset of data fails to map to a corresponding target object in the model.

In another exemplary aspect, a microcontroller system for controlling an unmanned movable object is disclosed. The system includes a processor configured to implement a method of tracking objects in real-time or near real-time. The method includes receiving data indicative of actual locations of surrounding objects. The actual locations are grouped into a plurality of groups by a segmentation module, and each group of the plurality of groups corresponds to one of the surrounding objects. The method also includes obtaining a plurality of models of target objects based on the plurality of groups, estimating a motion matrix for each of the target objects, updating the model using the motion matrix for each of the target objects, and optimizing the model by modifying the model for each of the target objects to remove or reduce a physical distortion of the model for the target object.

In yet another exemplary aspect, an unmanned device is disclosed. The unmanned device includes light detection and ranging (LIDAR) based object tracking system as described above, a controller operable to generate control signals to direct motion of the vehicle in response to output from the real-time object tracking system, and an engine operable to maneuver the vehicle in response to control signals from the controller.

The above and other aspects and their implementations are described in greater detail in the drawings, the description and the claims.

### BRIEF DESCRIPTION OF THE DRAWINGS

FIG. 1A shows an exemplary LIDAR system coupled to an unmanned vehicle.

FIG. 1B shows a visualization of an exemplary set of point cloud data with data points representing surrounding objects.

FIG. 2A shows a block diagram of an exemplary object tracking system in accordance with one or more embodiments of the present technology.

FIG. 2B show an exemplary overall workflow of an object tracker in accordance with one or more embodiments of the present technology.

FIG. 3 shows an exemplary flowchart of a method of object identification.

FIG. 4 shows an exemplary bipartite graph with edges connecting P′_{t,target} and P_{t,surrounding}.

FIG. 5 shows an exemplary mapping of P_{t,surrounding} to P_{t-1,target} based on point cloud data collected for a car.

FIG. 6 shows an exemplary flowchart of a method of motion estimation.

FIG. 7 shows an exemplary multi-dimensional Gaussian distribution model for a target object moving at 7 m/sec along X axis.

FIG. 8 shows an exemplary flowchart of a method of optimizing the models of the target objects to minimize motion blur effect.

### DETAILED DESCRIPTION

With the ever increasing use of unmanned movable objects, such as unmanned vehicles, it is important for them to be able to independently detect obstacles and to automatically engage in obstacle avoidance maneuvers. Light detection and ranging (LIDAR) is a reliable and stable detection technology because LIDAR can remain functional under nearly all weather conditions. Moreover, unlike traditional image sensors (e.g., cameras) that can only sense the surroundings in two dimensions, LIDAR can obtain three-dimensional information by detecting the depth. However, traditional LIDAR systems are typically expensive because they rely on multi-channel, high-speed, high-density LIDAR emitters and sensors. The cost of such LIDARs, together with the cost of having sufficient processing power to process the dense data, makes the price of traditional LIDAR systems formidable. This patent document describes techniques and methods for utilizing multiple low-cost single-channel linear LIDAR emitter and sensor pairs to achieve multi-object tracking by unmanned vehicles. The disclosed techniques are capable of achieving multi-object tracking with a much lower data density (e.g., around 1/10 of the data density in traditional approaches) while maintaining similar precision and robustness for object tracking.

In the following description, the example of a unmanned vehicle is used, for illustrative purposes only, to explain various techniques that can be implemented using a LIDAR object tracking system that is more cost-effective than the traditional LIDARs. For example, even though one or more figures introduced in connection with the techniques illustrate a unmanned car, in other embodiments, the techniques are applicable in a similar manner to other type of movable objects including, but not limited to, an unmanned aviation vehicle, a hand-held device, or a robot. In another example, even though the techniques are particularly applicable to laser beams produced by laser diodes in a LIDAR system, the scanning results from other types of object range sensor, such as a time-of-flight camera, can also be applicable.

In the following, numerous specific details are set forth to provide a thorough understanding of the presently disclosed technology. In some instances, well-known features are not described in detail to avoid unnecessarily obscuring the present disclosure. References in this description to “an embodiment,” “one embodiment,” or the like, mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. Also, it is to be understood that the various embodiments shown in the figures are merely illustrative representations and are not necessarily drawn to scale.

In this patent document, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

### Overview

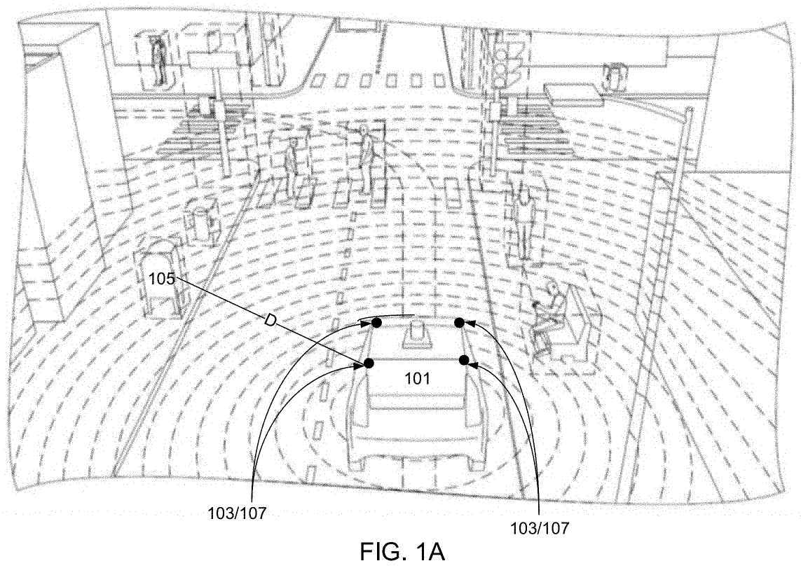

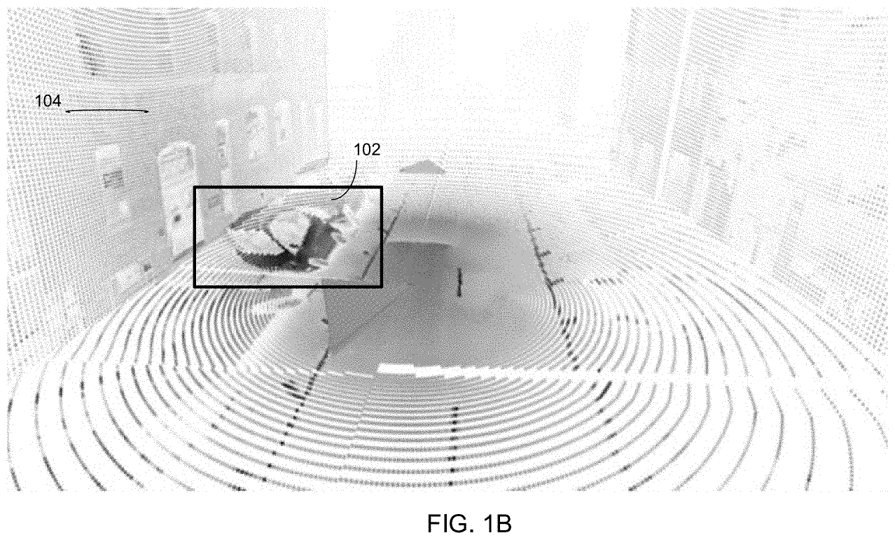

FIG. 1A shows an exemplary LIDAR system coupled to an unmanned vehicle 101. In this configuration, the unmanned vehicle 101 is equipped with four LIDAR emitter and sensor pairs. The LIDAR emitters 103 are coupled to the unmanned vehicle 101 to emit a light signal (e.g., a pulsed laser). Then, after the light signal is reflected by a surrounding object, such as object 105, the LIDAR sensors 107 detect the reflected light signal, and measure the time passed between when the light is emitted and when the reflected light is detected. The distance D to the surrounding object 105 can be calculated based on the time difference and the estimated speed of light, for example, “distance=(speed of light×time of flight)/2.” With additional information such as the angle of the emitting light, three dimensional (3D) information of the surroundings can be obtained by the LIDAR system.

The 3D information of the surroundings is commonly stored as data in a format of point cloud—a set of data points representing actual locations of surrounding objects in a selected coordinate system. FIG. 1B shows a visualization of an exemplary set of data in point cloud format collected by an unmanned vehicle using a LIDAR object tracking system in accordance with one or more embodiments of the present technology. The data points in the point cloud represent the 3D information of the surrounding objects. For example, a subset of the points 102 obtained by the LIDAR emitter and sensor pairs indicate the actual locations of the surface points of a car. Another subset of the points 104 obtained by the LIDAR emitter and sensor pairs indicate the actual locations of the surface points of a building. The use of multiple single-channel linear LIDAR emitter and sensor pairs, as compared to multi-channel, high-speed, and high-density LIDARs, results in a much more sparse point cloud data set. For example, a traditional Velodyne LIDAR system includes a 64-channel emitter and sensor pair that is capable of detecting 2.2 million points per second. The data density of the point cloud data from four to six single-channel linear LIDAR emitter and sensor pairs is only about 0.2 million points per second. The lower data density allows more flexibility for real-time object tracking applications, but demands improved techniques to handle the sparse point cloud data in order to achieve the same level of robustness and precision of object tracking.

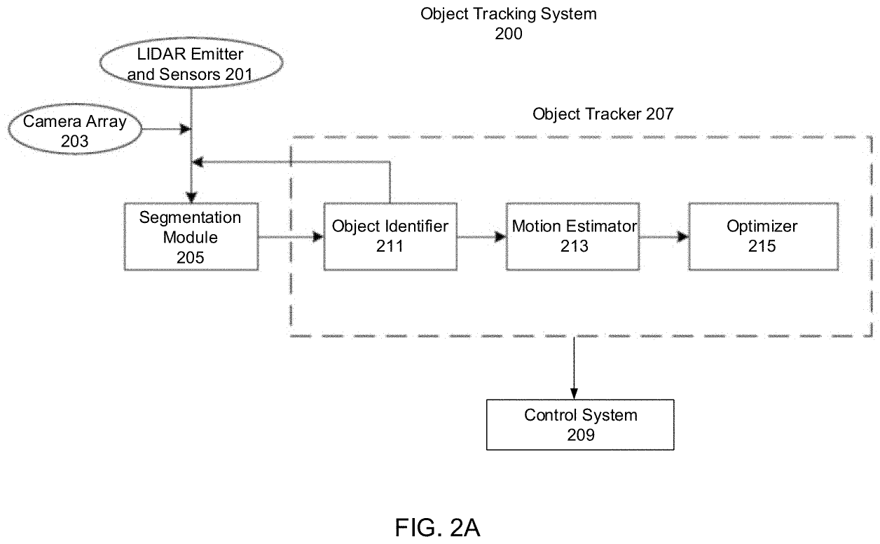

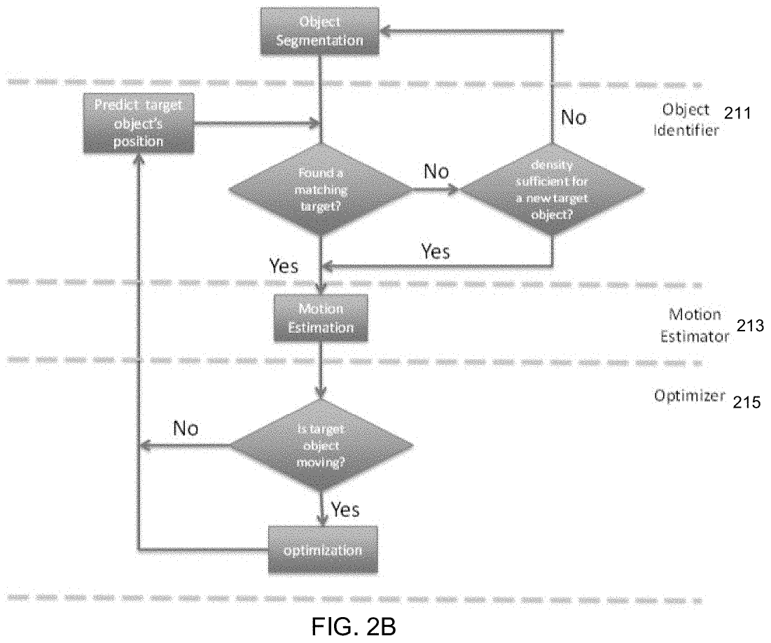

FIG. 2A shows a block diagram of an exemplary object tracking system in accordance with one or more embodiments of the present technology. As discussed above, the object tracking system is capable of robust object tracking given a low data density of point cloud data. As illustrated in FIG. 2A, the object tracking system 200 includes a plurality of LIDAR emitter and sensor pairs 201. The emitter and sensor pairs 201 first emit light signals to the surroundings and then obtain the corresponding 3D information. The object tracking system 200 may optionally include a camera array 203. Input from a camera array 203 can be added to the point cloud to supplement color information for each of the data points. Additional color information can lead to better motion estimation.

The 3D information of the surroundings is then forwarded into a segmentation module to group the data points into various groups, each of the group corresponding to a surrounding object. The point cloud, as well as the results of segmentation (i.e., the groups), are fed into an object tracker 207. The object tracker 207 is operable to build models of target objects based on the point cloud of the surrounding objects, compute motion estimations for the target objects, and perform optimization to the models in order to minimize the effect of motion blur. Table 1 and FIG. 2B show an exemplary overall workflow of an object tracker 207 in accordance with one or more embodiments of the present technology. For example, the input to the object tracker 207, denoted as Sₜ, includes both the point cloud data for the surrounding objects and the corresponding groups from the segmentation module 205 at time t. Based on the input Sₜ, the object tracker 207 builds point cloud models P_{t,target} for a set of target objects. The object tracker 207 also estimates respective motions M_{t,target} for these target objects. In some embodiments, the motion estimation M for a target object includes both translation and rotation, and can be represented as M={x, y, z, roll, pitch, yaw}.

When the object tracker 207 initializes, it has zero target objects. Given some initial input data, it first identifies a target object that is deemed static with an initial motion estimation of Mᵢₙᵢₜ={0}. Upon receiving subsequent input Sₜ from the segmentation module 205, the object tracker 207 performs object identification, motion estimation, and optimization to obtain updated models for the target objects P_{t,target} at time t. Because the input date density from the LIDAR emitter-sensor pairs is relatively low, there could exist unidentified data points in Sₜ that cannot be mapped to any of the target objects. Such unidentified data points may be fed back to the segmentation module 205 for further segmentation at the next time t+1.

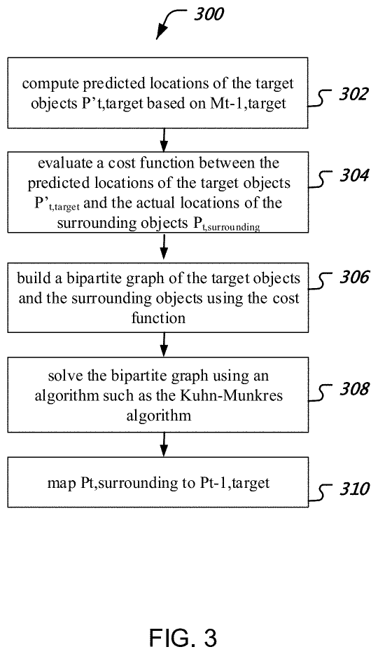

The object tracker 207 may include three separate components to complete the main steps shown in Table 1: an object identifier 211 that performs object identification, a motion estimator 213 that performs motion estimations, and an optimizer 215 that optimizes the models of the target objects. These components can be implemented in special-purpose computers or data processors that are specifically programmed, configured or constructed to perform the respective functionalities. Alternatively, an integrated component performing all these functionalities can also be implemented in a special-purpose computer or processor. Details regarding the functionalities of the object identifier 211, the motion estimator 213, and the optimizer 215 will be described in further details in connection with FIGS. 3-8.

The output of the object tracker 207, which includes models of target objects and the corresponding motion estimations, is then used by a control system 209 to facilitate decision making regarding the maneuver of the unmanned vehicle to avoid obstacles and to conduct adaptive cruising and/or lane switching.

TABLE 1
Exemplary Workflow for the Object Tracker

| | |
|---|---|
| Input | Point cloud and classification result Sₜ. |
| Output | The model P_{t,target} for the target objects and the corresponding motion |
| | estimation M_{t,target}. |
| Feedback | Unidentified data points in Sₜ. |
| Initial State | Initially, the target objects are set to be empty. The motion estimation is also set |
| | to be static. |
| Workflow | 1. Object identification. |
| | Based on the M_{t-1,target}, identify surrounding objects in Sₜ and match them with |
| | the target objects in the models P_{t-1,target}. |
| | Evaluate whether any unidentified data points in Sₜ should be deemed as one or |
| | more new target objects, or should be fed back to the segmentation module for |
| | further segmentation. |
| | 2. Motion estimation. |
| | For all P_{t-1,target}: |
| | If there exists P_{t,surrounding} ϵ Sₜ that matches to P_{t-1,target}: |
| | Use M_{t-1,target} as a prior constraint, compute M_{t,target} based on P_{t,surrounding} |
| | and P_{t-1,target}. |
| | Update P_{t,target} using M_{t,target}. |
| | Otherwise: |
| | M_{t,target} = M_{t-1,target} and |
| | P_{t,target} = M_{t,target}* P_{t-1,target} |
| | 3. Optimization. |
| | For all target objects in P_{t,target}: |
| | If the target object is a moving object, optimize its corresponding P_{t,target} to |
| | remove motion blur effects. |

### Object Identification

FIG. 3 shows an exemplary flowchart of a method of object identification 300. An object identifier 211 implementing the method 300 first computes, at 302, the predicted locations of target objects P′_{t,target} at time t based on the estimation of motion M_{t-1,target} at time t−1:

P_{t,target}^{′}=M_{t-1,target}*P_{t-1,target} Eq. (1)

Based on the predicted locations of the target objects P′_{t,target} and the actual locations of the surrounding objects P_{t,surrounding}, a similarity function co between the target objects and the surrounding objects can be evaluated, at 304, using a cost function F:

ω_{target,surrounding}=F(P_{t,target}^{′},P_{t,surrounding}) Eq. (2)

The cost function F can be designed to accommodate specific cases. For example, F can simply be the center distance of the two point clouds P′_{t,target} and P_{t,surrounding}, or the number of voxels commonly occupied by both P′_{t,target} and P_{t,surrounding}. In some embodiments, the cost function F(P,Q) can be defined as:

F(P,Q)=Σ_{p∈P}∥p−q∥₂, Eq. (3)

where p is a point in point cloud P and q is the closest point to point p in point cloud Q. The cost function F can also include color information for each point data supplied by the camera array 203, as shown in FIG. 2. The color information can be a greyscale value to indicate the brightness of each point. The color information may also be a 3-channel value defined in a particular color space for each point (e.g., RGB or YUV value).

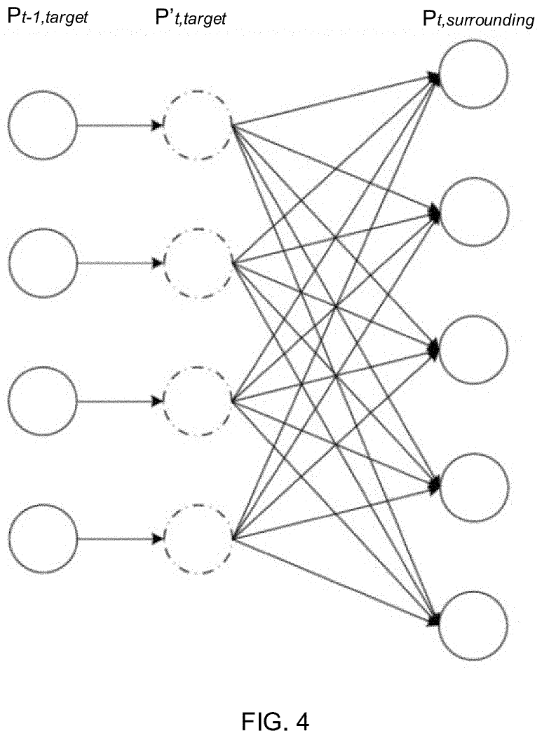

Given the cost function F, a bipartite graph can be built, at 306, for all points contained in P′_{t,target} and P_{t,surrounding}. FIG. 4 shows an exemplary bipartite graph with edges connecting P′_{t,target} and P_{t,surrounding}. Each edge in the graph is given a weight that is calculated using the cost function F. The bipartite graph can be solved, at 308, using an algorithm such as the Kuhn-Munkres (KM) algorithm.

A complete bipartite graph can be built for all points in the target objects and all points in the surrounding objects. However, the computational complex of solving the complete bipartite graph is O(n\hat{ }3) where n is the number of objects. The performance can be substantially impacted when there is a large number of objects in the scene. To ensure the real time performance, subgraphs of the complete bipartite graph can be identified using the location information of the target object. This is based on an assumption that a target object is unlikely to undergo substantial movement between time t−1 and t. Its surface points are likely to located within a relative small range within the point cloud data set. Due to such locality of the data points, the complete bipartite graph can be divided into subgraphs. Each of the subgraph can be solved sequentially or concurrently using algorithms such as the KM algorithm.

After solving the bipartite graph (or subgraphs), the object tracker obtains, at 310, a mapping of the surrounding objects P_{t,surrounding} to the target objects P_{t-1,target}. In some cases, after solving the bipartite graph or subgraphs, not all target objects at time t-1 are map to objects in P_{t,surrounding}. This can happen when an object temporarily occluded by another object and becomes invisible to the LIDAR tracking system. For example, at time t, the object tracker cannot find a corresponding group within P_{t,surrounding} for the target object A. The object tracker considers the target object A still available and assigns a default motion estimation M_{default} to it. The object tracker further updates object A's model using M_{default}: P_{t,A}=M_{default}*P_{t-1,A}. Once the object becomes visible again, the system continues to track its locations. On the other hand, if the object tracker continuously fails to map any of the surrounding objects to the target object A for a predetermined amount of time, e.g., 1 second, the object tracker considers the target object A missing as if it has permanently moved outside of the sensing range of the LIDAR emitter-sensor pairs. The object tracker then deletes this particular target object from the models.

In some cases, not all surrounding objects P_{t,surrounding} in the input can be mapped to corresponding target objects. For example, the object tracker fails to map a group of points Bₚ in Sₜ, indicative of a surrounding object B, to any of the target objects P_{t-1,target}. To determine if the group of points Bₚ is a good representation of the object B, the object tracker evaluates the point density of Bₚ based on the amount of points in Bₚ and the distance from B to the LIDAR emitter-sensor pairs. For example, if the object B is close to the LIDAR emitter-sensor pairs, the object tracker requires more data points in Bₚ to be a sufficient representation of object B. On the other hand, if object B is far away from the LIDAR emitter-sensor pairs, even a small amount of data points in Bₚ may be sufficient to qualify as a good representation of object B. When the density is below a predetermined threshold, the object tracker 207 feeds the data points back to the segmentation module 205 for further segmentation at time t+1. On the other hand, if the group of data points has sufficient density and has presented in input data set for longer than a predetermined amount of time, e.g., 1 second, the object tracker 207 deems this group of points to be a new target object and initializes its states accordingly.

Motion Estimation

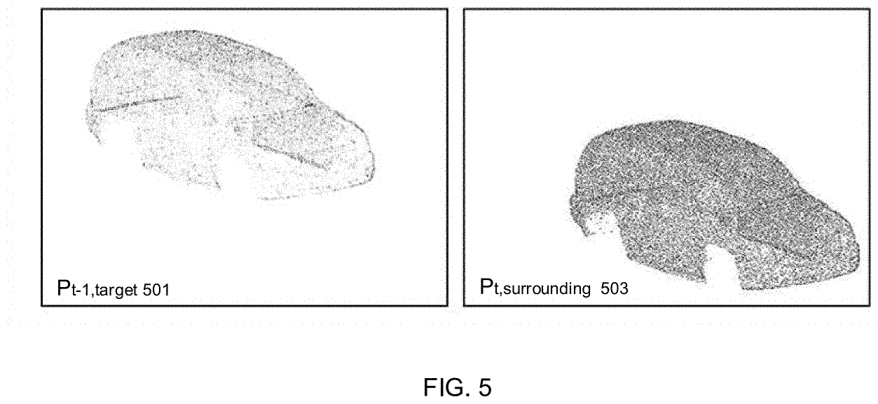

After object identification, the object tracker now obtains a mapping of P_{t,surrounding} to P_{t-1,target}. FIG. 5 shows an exemplary mapping of P_{t,surrounding} to P_{t-1,target} based on point cloud data collected for a car. The target model of the car P_{t-1,target} is shown as 501 at time t−1, while the surrounding model of the car P_{t,surrounding} is shown as 503 at time t.

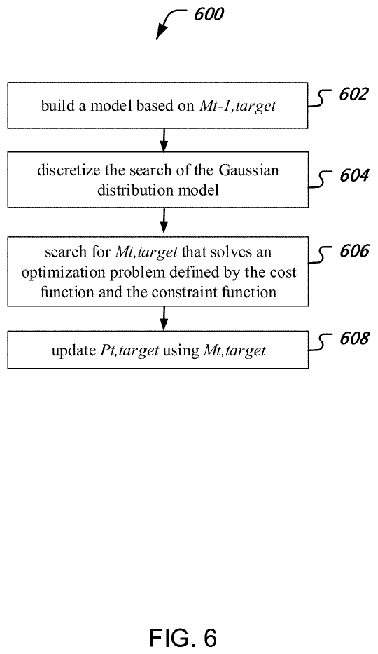

Based on P_{t-1,target} and P_{t,surrounding}, the object tracker can compute a motion estimation M_{t,target} for time t. FIG. 6 shows an exemplary flowchart of a method of motion estimation 600. Because motions of the target objects are not expected to undertake dramatic changes between time t−1 and time t, the motion estimation M_{t,target} can be viewed as being constrained by M_{t-1,target} A motion estimator 213 implementing the method 600, therefore, can build, at 602, a model for M_{t,target} using M_{t-1,target} as a prior constraint. In some embodiments, a multi-dimensional Gaussian distribution model is built with a constraint function T defined as:

T(Mₜ,Mₜ₋₁)=(Mₜ−μₜ₋₁)^{T}Σₜ₋₁⁻¹(Mₜ−μₜ₋₁) Eq. (4)

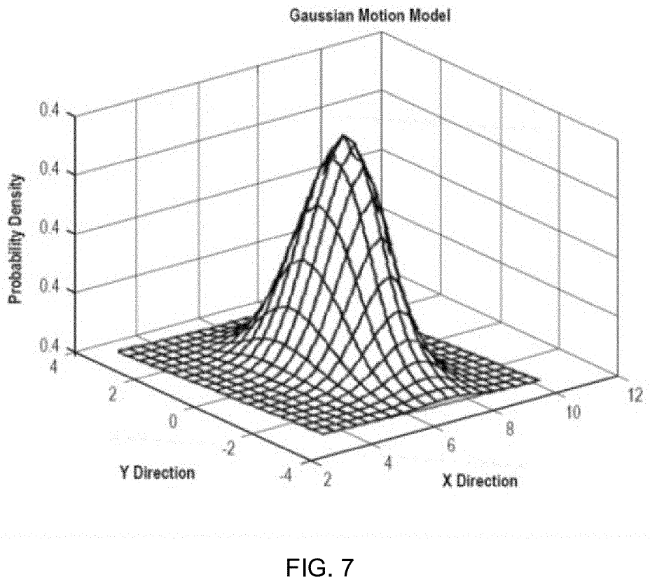

The constraint function T can describe uniform motion, acceleration, and rotation of the target objects. For example, FIG. 7 shows an exemplary multi-dimensional Gaussian distribution model for a target object moving with a uniform motion at 7 m/sec along the X axis.

After the motion estimator 213 builds a model based on Mₜ₋₁, target, the motion estimation problem can essentially be described as solving an optimization problem defined as:

$$arg {min}_{{M}_{t}} F ( {M}_{t} * {P}_{t - 1} , {P}_{t} ) + λ T ( {M}_{t} , {M}_{t - 1} ) \qquad Eq . ( 5 )$$

where λ is a parameter that balances the cost function F and the constraint function T. Because this optimization problem is highly constrained, the motion estimator 213 can discretize, at 604, the search of the Gaussian distribution model using the constraint function T as boundaries. The optimization problem is then transformed to a search problem for Mₜ. The motion estimator 213 then, at 606, searches for Mₜ within the search space defined by the discretized domain so that Mₜ minimizes:

F(Mₜ*Pₜ₋₁,Pₜ)+λT(Mₜ,Mₜ₋₁). Eq. (6)

In some embodiments, the motion estimator 213 can change the discretization step size adaptively based on density of the data points. For example, if object C is located closer to the LIDAR emitter-sensor pairs, the motion estimator 213 uses a dense discretization search scheme in order to achieve higher accuracy for the estimated results. If object D, on the other hand, is located further from the LIDAR emitter-sensor pairs, a larger discretization step size can be used for better search efficiency. Because evaluating Eq. (5) is mutually independent for each of the discretized step, in some embodiments, the search is performed concurrently on a multicore processor, such as a graphic processing unit (GPU), to increase search speed and facilitate real-time object tracking responses.

Lastly, after M_{t,target} is found in the discretized model, the motion estimator 213 updates, at 608, the point cloud models for the target objects based on the newly found motion estimation:

P_{t,target}=M_{t,target}*P_{t-1,target} Eq. (7)

Optimization

Because some of the target objects move at a very fast speed, a physical distortion, such as motion blur, may present in models for the target objects. The use of low-cost single-channel linear LIDAR emitter and sensor pairs may exacerbate this problem because, due to the low data density sensed by these LIDARs, it is desirable to have a longer accumulation time to accumulate sufficient data points for object classification and tracking. Longer accumulation time, however, means that there is a higher likelihood to encounter physical distortion in the input data set. An optimizer 215 can be implemented to reduce or remove the physical distortion in the models for the target objects and improve data accuracy for object tracking.

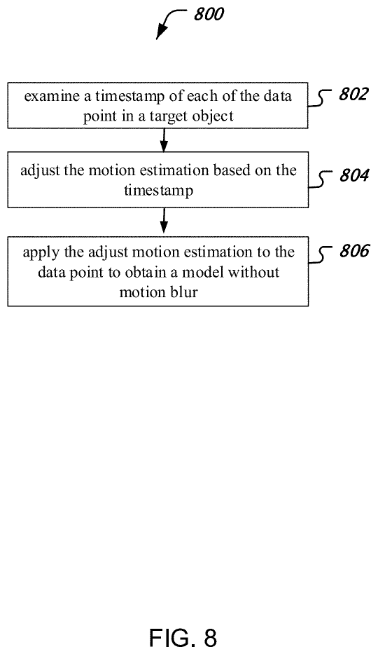

FIG. 8 shows an exemplary flowchart of a method of optimizing the models of the target objects to reduce or remove the physical distortion. When the point cloud data set is sensed by the LIDAR emitter and sensor pairs, each of the point in Sₜ (and subsequently P_{t,surrounding}) is associated with a timestamp. This timestamp can be assigned to the corresponding point in the target object model P_{t-1,target} after the object identifier 211 obtains a mapping of P_{t,surrounding} and P_{t-1,target}, and further be assigned to the corresponding point in P_{t,target} after the motion estimator 213 updates P_{t,target} using P_{t-1,target}.

For example, for a particular point object E (that is, an object having only one point), n input data points, ρ₀, ρ₁, . . . , ρₙ₋₁ ∈P_{t,surrounding} are collected during the time Δt between t−1 and t. The data points are associated with timestamps defined as tᵢ=t−(n−i)*Δt, where Δt is determined by the sensing frequency of the LIDAR emitter and sensor pairs. Subsequently, these data points are mapped to P_{t-1,target}. When the object tracker updates the model P_{t,target} for time t, the timestamps for ρ₀, ρ₁, . . . , ρₙ₋₁ are assigned to the corresponding points in the model P_{t,target}. These multiple input data points cause physical distortion of the point object D in P_{t,target}.

After the motion estimation M_{t,target} relative to the LIDAR system for time t is known, the absolution estimated motion for the target M_absolute_{t,target} can be obtained using M_{t,target} and the speed of the LIDAR system. In some embodiments, the speed of the LIDAR system can be measured using an inertial measurement unit (IMU). Then, the optimizer 215, at 802, examines timestamps of each of the points in a target object P_{t,target}. For example, for the point object E, the accumulated point cloud data (with physical distortion) can be defined as:

Uᵢ₌₀ⁿ⁻¹ρᵢ Eq. (8)

The desired point cloud data (without physical distortion), however, can be defined as:

ρ=Uᵢ₌₀ⁿ⁻¹M_absolute′ti*ρᵢ Eq. (9)

where M_absolute′ₜᵢ is an adjusted motion estimation for each data point ρᵢ at time tᵢ. The optimizer 215 then, at 804, computes the adjusted motion estimation based on the timestamps of each point.

There are several ways to obtain the adjusted motion estimation M_absolute′ₜᵢ. In some embodiments, M_absolute′ₜᵢ can be computed by evaluating M_absolute_{t,target} at different timestamps. For example, given M_absolute_{t,target}, a velocity V_{t,target} of the target object can be computed. M_absolute′ₜᵢ, therefore, can be calculated based on M_absolute_{t,target} and (n−i)*Δt*V_{t,target}. Alternatively, a different optimization problem defined as follows can be solved to obtain M_absolute′ₜᵢ:

$$arg {min}_{M} {F}^{′} ( ρ ) + {λ}_{o} {‖ M - {M}^{′} ‖}_{2} \qquad Eq . ( 10 )$$

where F′ can be defined in a variety of ways, such as the number of voxels ρ occupies. A similar discretized search method as described above can be applied to find the solution to M′.

Finally, after adjusting the motion estimation based on the timestamp, the optimizer 315 applies, at 806, the adjusted motion estimation to the corresponding data point to obtain a model with reduced physical distortion.

It is thus evident that, in one aspect of the disclosed technology, a light detection and ranging (LIDAR) based object tracking system. The system includes a plurality of light emitter and sensor pairs. Each pair of the plurality of light emitter and sensor pairs is operable to obtain data indicative of actual locations of surrounding objects. The data is grouped into a plurality of groups by a segmentation module, with each group corresponding to one of the surrounding objects. The system also includes an object tracker configured to (1) build a plurality of models of target objects based on the plurality of groups, (2) compute a motion estimation for each of the target objects, and (3) feed a subset of data back to the segmentation module for further classification based on a determination by the object tracker that the subset of data fails to map to a corresponding target object in the model.

In some embodiments, the object tracker includes an object identifier that (1) computes a predicted location for a target object among the target objects based on the motion estimation for the target object and (2) identifies, among the plurality of groups, a corresponding group that matches the target object. The object tracker also includes a motion estimator that updates the motion estimation for the target object by finding a set of translation and rotation values that, after applied to the target object, produces a smallest difference between the predicted location of the target object and the actual location of the corresponding group, wherein the motion estimator further updates the model for the target object using the motion estimation. The object tracker further includes an optimizer that modifies the model for the target object by adjusting the motion estimation to reduce or remove a physical distortion of the model for the target object.

In some embodiments, the object identifier identifies the corresponding group by evaluating a cost function, the cost function defined by a distance between the predicted location of the target object and the actual location of a group among the plurality of groups.

In some embodiments, the object tracking system further includes a camera array coupled to the plurality of light emitter and sensor pairs. The cost function is further defined by a color difference between the target object and the group, the color difference determined by color information captured by the camera array. The color information includes a one-component value or a three-component value in a predetermined color space.

In some embodiments, the object identifier identifies the corresponding group based on solving a complete bipartite graph of the cost function. In solving the complete bipartite graph, the object identifier can divide the complete bipartite graph to a plurality of subgraphs based on a location information of the target objects. The object identifier can solve the plurality of subgraphs based on a Kuhn-Munkres algorithm.

In some embodiments, the object identifier, upon determining that a target object fails to map to any of the actual locations of the surrounding objects for an amount of time no longer than a predetermined threshold, assigns the target object a uniform motion estimation. The object identifier may, upon determining that a target object fails to map to any of the actual locations of the surrounding objects for an amount of time longer than the predetermined threshold, remove the target object from the model.

In some embodiments, the object identifier, in response to a determination that the subset of data fails to map to any of the target objects, evaluates a density of the data in the subset, adds the subset as a new target object to the model when the density is above a predetermined threshold, and feeds the subset back to the segmentation module for further classification when the density is below the predetermined threshold.

In some embodiments, the motion estimator conducts a discretized search of a Gaussian motion model based on a set of predetermined, physics-based constraints of a given target object to compute the motion estimation. The system may further includes a multicore processor, wherein the motion estimator utilizes the multicore processor to conduct the discretized search of the Gaussian motion model in parallel. In some embodiments, the optimizer modifies the model for the target object by applying one or more adjusted motion estimations to the model.

In another aspect of the disclosed technology, a microcontroller system for controlling an unmanned movable object is disclosed. The system includes a processor configured to implement a method of tracking objects in real-time or near real-time. The method includes receiving data indicative of actual locations of surrounding objects. The actual locations are classified into a plurality of groups by a segmentation module, and each group of the plurality of groups corresponds to one of the surrounding objects. The method also includes obtaining a plurality of models of target objects based on the plurality of groups; estimating a motion matrix for each of the target objects; updating the model using the motion matrix for each of the target objects; and optimizing the model by modifying the model for each of the target objects to remove or reduce a physical distortion of the model for the target object.

In some embodiments, the obtaining of the plurality of models of the target objects includes computing a predicted location for each of the target objects; and identifying, based on the predicted point location, a corresponding group among the plurality of groups that maps to a target object among the target objects. The identifying of the corresponding group can include evaluating a cost function that is defined by a distance between the predicted location of the target object and the actual location of a group among the plurality of groups.

In some embodiments, the system further includes a camera array coupled to the plurality of light emitter and sensor pairs. The cost function is further defined by a color difference between the target object and the group, the color difference determined by color information captured by a camera array. The color information may include a one-component value or a three-component value in a pre-determined color space.

In some embodiments, the identifying comprises solving a complete bipartite graph of the cost function. In solving the complete bipartite graph, the processor divides the complete bipartite graph to a plurality of subgraphs based on a location information of the target objects. The processor can solve the plurality of subgraphs using a Kuhn-Munkres algorithm.

In some embodiments, the identifying comprises assigning a target object a uniform motion matrix in response to a determination that that the target object fails to map to any of the actual locations of the surrounding objects for an amount of time shorter than a predetermined threshold. The identifying may include removing a target object from the model in response to a determination that the target object fails to map to any of the actual locations of the surrounding objects for an amount of time longer than the predetermined threshold. The identifying may also include, in response to a determination that a subset of the data fails to map to any of the target objects, evaluating a density of data in the subset, adding the subset as a new target object if the density is above a predetermined threshold, and feeding the subset back to the segmentation module for further classification based on a determination that the density is below the predetermined threshold.

In some embodiments, the estimating includes conducting a discretized search of a Gaussian motion model based on a set of prior constraints to estimate the motion matrix, wherein a step size of the discretized search is determined adaptively based on a distance of each of the target objects to the microcontroller system. The conducting can include subdividing the discretized search of the Gaussian motion model into sub-searches and conducting the sub-searches in parallel on a multicore processor.

In some embodiments, the optimizing includes evaluating a velocity of each of the target objects, and determining, based on the evaluation, whether to apply one or more adjusted motion matrices to the target object to remove or reduce the physical distortion of the model.

In yet another aspect of the disclosed technology, an unmanned device is disclosed. The unmanned device comprises a light detection and ranging (LIDAR) based object tracking system as described above, a controller operable to generate control signals to direct motion of the vehicle in response to output from the real-time object tracking system, and an engine operable to maneuver the vehicle in response to control signals from the controller.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A light detection and ranging (LIDAR) based object tracking system, comprising:
a plurality of light emitter and sensor pairs, wherein each pair of the plurality of light emitter and sensor pairs is operable to obtain data indicative of actual locations of surrounding objects, wherein the data is grouped into a plurality of groups by a segmentation module, each group corresponding to one of the surrounding objects; and
an object tracker configured to (1) build a plurality of models of target objects based on the plurality of groups, (2) compute a motion estimation for each of the target objects, and (3) feed a subset of data back to the segmentation module for further grouping based on a determination by the object tracker that the subset of data fails to map to a corresponding target object in the model.

2. The object tracking system of claim 1, wherein the object tracker comprises:
an object identifier that (1) computes a predicted location for a target object among the target objects based on the motion estimation for the target object and (2) identifies, among the plurality of groups, a corresponding group that matches the target object;
a motion estimator that updates the motion estimation for the target object by finding a set of translation and rotation values that, after applied to the target object, produces a smallest difference between the predicted location of the target object and the actual location of the corresponding group, wherein the motion estimator further updates the model for the target object using the motion estimation; and
an optimizer that modifies the model for the target object by adjusting the motion estimation to reduce or remove a physical distortion of the model for the target object.

3. The object tracking system of claim 2, wherein the object identifier identifies the corresponding group by evaluating a cost function, the cost function defined by a distance between the predicted location of the target object and the actual location of a group among the plurality of groups.

4. The object tracking system of claim 3, further comprising:
a camera array coupled to the plurality of light emitter and sensor pairs;
wherein the cost function is further defined by a color difference between the target object and the group, the color difference determined by color information captured by the camera array.

5. The object tracking system of claim 3, wherein the object identifier identifies the corresponding group based on solving a complete bipartite graph of the cost function.

6. The object tracking system of claim 2, wherein the object identifier, upon determining that a target object fails to map to any of the actual locations of the surrounding objects for an amount of time no longer than a predetermined threshold, assigns the target object a uniform motion estimation.

7. The object tracking system of claim 2, wherein the object identifier, upon determining that a target object fails to map to any of the actual locations of the surrounding objects for an amount of time longer than a predetermined threshold, removes the target object from the model.

8. The object tracking system of claim 2, wherein the object identifier, in response to a determination that the subset of data fails to map to any of the target objects:
evaluates a density of the data in the subset,
adds the subset as a new target object to the model when the density is above a predetermined threshold, and
feeds the subset back for further grouping when the density is below the predetermined threshold.

9. The object tracking system of claim 2, wherein the motion estimator conducts a discretized search of a Gaussian motion model based on a set of predetermined, physics-based constraints of a given target object to compute the motion estimation.

10. The object tracking system of claim 9, further comprising:
a multicore processor;
wherein the motion estimator utilizes the multicore processor to conduct the discretized search of the Gaussian motion model in parallel.

11. The object tracking system of claim 2, wherein the optimizer modifies the model for the target object by applying one or more adjusted motion estimations to the model.

12. A microcontroller system for controlling an unmanned movable object, the system including a processor configured to implement a method of tracking objects in real-time or near real-time, the method comprising:
receiving data indicative of actual locations of surrounding objects from a plurality of light emitter and sensor pairs, wherein the actual locations are classified into a plurality of groups by a segmentation module, each group of the plurality of groups corresponding to one of the surrounding objects;
obtaining a plurality of models of target objects based on the plurality of groups;
estimating a motion matrix for each of the target objects;
updating the model using the motion matrix for each of the target objects; and
optimizing the model by modifying the model for each of the target objects to remove or reduce a physical distortion of the model for the target object.

13. The system of claim 12, wherein the obtaining of the plurality of models of the target objects comprises:
computing a predicted location for each of the target objects; and
identifying, based on the predicted location, a corresponding group among the plurality of groups that maps to a target object among the target objects.

14. The system of claim 13, wherein the identifying of the corresponding group comprises evaluating a cost function, the cost function defined by a distance between the predicted location of the target object and the actual location of a group among the plurality of groups.

15. The system of claim 14, wherein the cost function is further defined by a color difference between the target object and the group, the color difference determined by color information captured by a camera array coupled to the plurality of light emitter and sensor pairs.

16. The system of claim 13, wherein the identifying comprises assigning a target object a uniform motion matrix in response to a determination that the target object fails to map to any of the actual locations of the surrounding objects for an amount of time shorter than a predetermined threshold.

17. The system of claim 13, wherein the identifying comprises removing a target object from the model in response to a determination that the target object fails to map to any of the actual locations of the surrounding objects for an amount of time longer than a predetermined threshold.

18. The system of claim 13, wherein the identifying comprises, in response to a determination that a subset of the data fails to map to any of the target objects:
evaluating a density of data in the subset,
adding the subset as a new target object if the density is above a predetermined threshold, and
feeding the subset back to the segmentation module for further classification based on a determination that the density is below the predetermined threshold.

19. The system of claim 12, wherein the estimating comprises:
conducting a discretized search of a Gaussian motion model based on a set of prior constraints to estimate the motion matrix, wherein a step size of the discretized search is determined adaptively based on a distance of each of the target objects to the microcontroller system.

20. The system of claim 19, wherein the conducting comprises subdividing the discretized search of the Gaussian motion model into sub-searches and conducting the sub-searches in parallel on a multicore processor.

21. The system of claim 12, wherein the optimizing comprises:
evaluating a velocity of each of the target objects, and
determining, based on the evaluation, whether to apply one or more adjusted motion matrices to the target object to remove or reduce the physical distortion of the model.

22. The system of claim 12, wherein the optimizing comprises:
evaluating, for each point in a plurality of points in the model of each of the target objects, a timestamp of the point;
obtaining, for each point in a subset of the plurality of points, an adjusted motion matrix based on the evaluation of the timestamp; and
applying the adjusted motion matrix to each point in the subset of the plurality points to modify the model.
